(19) United States
(12) Patent Application Publication
(10) Pub. No.: US 2003/0184934 A1
(43) Pub. Date: Oct. 2, 2003

(54) Power distribution circuitry including control unit IC

(76) Inventors: Michael J. Bushue, Belmont, CA (US); Andrew Rhodes Paullin, Woburn, MA (US)

Correspondence Address: B. Noel Kivlin, Conley, Rose, & Tayon, P.C., P.O. Box 398, Austin, TX, 78767, US

(21) Appl. No.: 10/112,898

(22) Filed: Apr. 1, 2002

(51) Int. Cl. H02H 3/00

(52) U.S. Cl. 361/62

(57) ABSTRACT

A power distribution circuit is disclosed. In one embodiment, the power distribution circuit includes a plurality of transistors and a control unit IC. First terminals of each of the transistors may be coupled to separate voltage sources. Second terminals of each of the transistors may be coupled to a common power node. An electronic system may receive power from one of the voltage sources when one of the transistors is on. The control unit IC may activate one or more of the transistors by driving a voltage to the control terminal of the transistor to be activated. The control unit IC may also monitor a voltage difference between the first terminal and the second terminal of each of the transistors. If the voltage of the second terminal becomes greater than the voltage of the first terminal for a given transistor, the control terminal may deactivate the transistor.

### BACKGROUND OF THE INVENTION

1. Field of the Invention

This invention relates to electronic circuits, and more particularly, to power distribution circuitry.

2. Description of the Related Art

In many electronic systems, power distribution requires that certain portions of the electronic circuit must be protected from faults. In addition, due to reliability requirements, the electronic circuitry may need to be able to draw power from multiple sources.

One method of distributing power to an electronic circuit from multiple sources includes the use of a diode OR gate. FIG. 1 illustrates an exemplary power distribution system using a diode OR gate. Electronic system 20 is coupled to the output of diode OR gate 10, which includes three diodes 11. The inputs to diode OR gate 10 are voltage sources V_{A}, V_{B}, and V_{C}. The positive terminal of each of these voltage sources is coupled to the anode of its respective diode 11. The output of diode OR gate 10 is coupled to electronic system 20, which receives power through this output. Any of the voltage sources may be able to satisfy the power needs of electronic system 20. By using three separate voltage sources, redundancy may be built into the system, thereby providing added reliability.

While a diode OR gate may be useful for distributing power to an electronic circuit from multiple sources, it may have drawbacks. Many typical diodes have a voltage drop in excess of 0.6 volts. In some cases, Schottky diodes, which have a smaller voltage drop (on the order of 0.4 volts) may be used. While the diode voltage drop may remain relatively constant during operation of an electronic circuit, significant changes in current demand may occur. Since power consumption is a product of voltage and current, current flowing through one or more of the diodes may result in significant power losses across the diodes. For example, if 10 amperes of current are drawn through a diode having a voltage drop of 0.6 volts, the power loss of the diode is 6 watts. This may be a substantial power loss for many systems. Waste heat may also be generated in association with this power loss, which may lead to additional cooling needs for the power distribution system.

Many power distribution circuits implement diode OR gates using discrete components. Often times, these discrete components may be configured to be mounted in plated through holes (PTH) in a printed circuit board (PCB). This may not be practical in some PCBs which have a large number of copper layers. PTH components are typically soldered to a PCB using a wave soldering process. However, wave soldering of PCBs may be impractical for a PCB having a large number of copper layers, as the layers may absorb a large amount of heat, thereby conducting the heat away from the PTH locations that are to be soldered. Application of additional heat to complete the wave soldering process may not be practical, as the additional heat may damage the PCB, particularly the surface layers.

### SUMMARY OF THE INVENTION

A power distribution circuit including a control unit IC (integrated circuit) is disclosed. In one embodiment, the power distribution circuit may include a plurality of transistors and a control unit IC. The first terminals of each of the plurality of transistors may each be coupled to separate voltage sources. The second terminal of each of the plurality of transistors may be coupled to a power node, which is further coupled to an electronic system. The electronic system may receive power from one of the voltage sources coupled to one of the first terminals when one of the plurality of transistors is on. A control terminal of each of the transistors may be coupled to the control unit IC. The control unit IC may activate (i.e. “turn on”) one or more of the plurality of transistors by driving a bias voltage onto the control terminal of the transistor to be activated. The control unit IC may also monitor a voltage difference between the first terminal and the second terminal of each of the transistors. If the voltage of the second terminal becomes greater than the voltage of the first terminal for a given transistor, the control terminal may deactivate the transistor.

### BRIEF DESCRIPTION OF THE DRAWINGS

Other aspects of the invention will become apparent upon reading the following detailed description and upon reference to the accompanying drawings in which:

FIG. 1 is a schematic diagram of a power distribution system wherein power from multiple voltage sources is distributed to an electronic circuit using a diode OR gate;

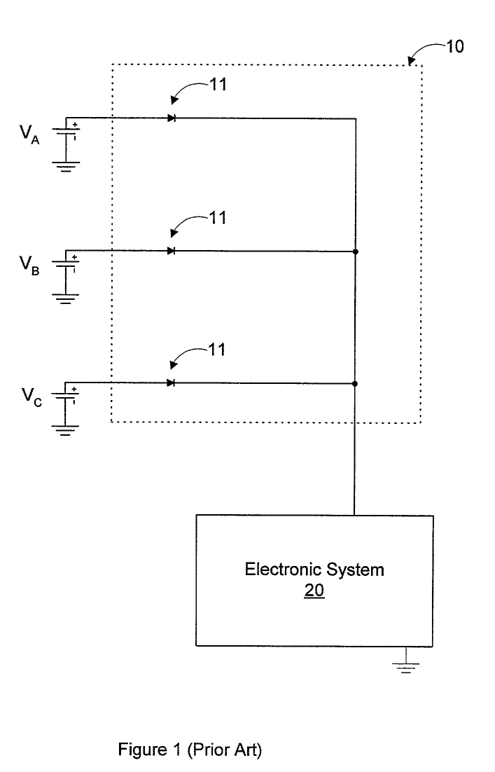

FIG. 2 is a schematic diagram of one embodiment of a power distribution circuit, wherein power is distributed to an electronic system from multiple sources;

FIG. 3 is a block diagram of one embodiment of a control unit IC; and

FIG. 4 is a schematic diagram of one embodiment of a control unit IC;

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications;, equivalents, and alternatives falling with the spirit and scope of the present invention as defined by the appended claims.

### DETAILED DESCRIPTION OF THE INVENTION

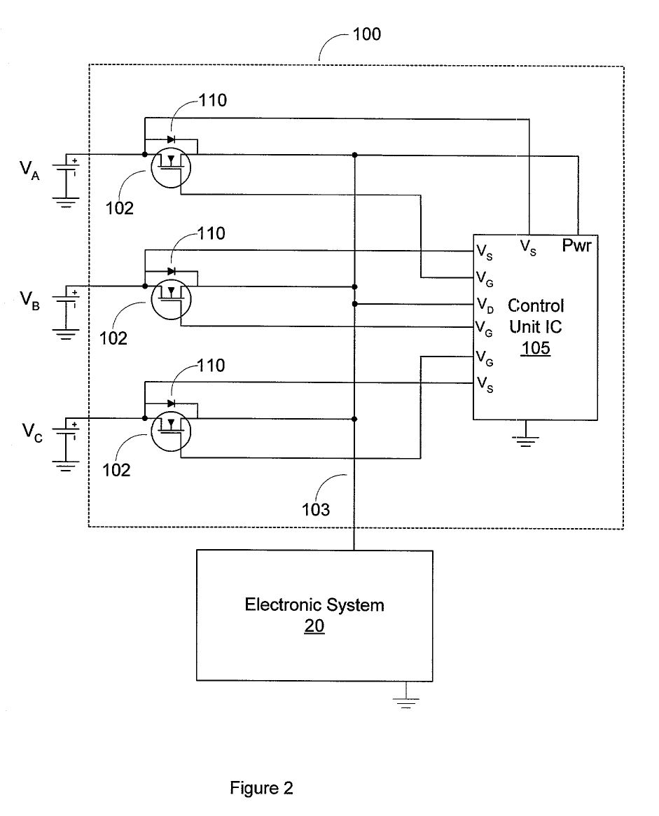

Turning now to FIG. 2, a schematic diagram of one embodiment of a power distribution circuit is shown. In the embodiment shown, power distribution circuit 100 is configured to supply power to electronic system 20. Electronic system 20 may be one of many types of electronic circuits (such as a computer system motherboard). In one embodiment, electronic system 20 may be a high availability system, such as a server, and may thus require some power supply redundancy to ensure both reliability and availability. Power supply redundancy may be provided by power sources V_{A}, V_{B}, and V_{C}. Each of these power sources may be configured to individually meet voltage and current requirements for electronic system 20. Power distribution circuit 100 may further allow for the power sources to work together in unison, thereby sharing the burden of supplying power to electronic system 20. While three power sources are shown in this particular embodiment, other embodiments of power distribution circuit 100 configured for a greater or lesser number of power sources are possible and contemplated.

Power distribution circuit 100 may be configured to distribute power to a system with relatively high voltage and current requirements. In one particular embodiment, a server system requiring 48 volts at 1-30 amperes of current may be supplied by power distribution circuit 100. Other types of electronic systems having different voltage and/or current requirements may be supplied by various embodiments of power distribution circuit 100.

In one embodiment, control unit IC 105 may be implemented as a single integrated circuit. Furthermore, it is contemplated that some embodiments including the entirety of power distribution circuit 100 may be implemented on a single integrated circuit. When control unit IC 105 (or the entire power distribution circuit 100) is implemented as an integrated circuit, it may be mounted within a surface mount package. The use of a surface mount package may be ideal for mounting on a printed circuit board (PCB) having a large number of copper layers. In many cases, the use of plated-through-hole (PTH) components may not be possible or practical on a PCB having a large number of copper layers. Heat dissipation in the copper layers may make wave soldering PTH components to the PCB difficult if not impossible. However, it may be necessary to use such a PCB for high current and/or voltage applications. Thus, the use of an integrated circuit within a surface mount package may be ideal for an application requiring a PCB with a large number of copper planes. Furthermore, the use of an integrated circuit may minimize the number of parts needed to implement the control functions, as well as eliminating extra assembly steps during the manufacture of the system in which power distribution circuit 105 is to be implemented.

Power sources V_{A}, V_{B}, and V_{C} may each be coupled to a power node 103 via transistors 102. In the embodiment shown, transistors 102 are field effect transistors (FETs). The types of FETs used may include MOSFETs (metal oxide semiconductor field effect transistors) and JFETs (junction field effect transistors). In addition, embodiments utilizing bipolar transistors are possible and contemplated.

In the embodiment shown, a source terminal of each transistor 102 is coupled to one of the power sources V_{A}, V_{B}, and V_{C}. A drain terminal of each transistor may be coupled to a common power node 103. Power may be distributed to electronic system 20 via power node 103. Power sources V_{A}, V_{B}, and V_{C} may each be configured to meet approximately the same specifications. In other words, each of power sources V_{A}, V_{B}, and V_{C} may be configured to supply the same voltage and the same current within a specified tolerance. Thus, the voltage potential present on power node 103 at any given time may be approximately the specified voltage for one of power sources V_{A}, V_{B}, and V_{C}.

FIG. 2 also shows a body diode 110 coupled between the voltage sources and power node 103. In this particular embodiment, the cathode of each body diode 110 is coupled to power node 103. In the embodiment shown, the body diodes 110 shown here are not actual circuit elements, but instead are representative of the diode function that may be provided by each of transistors 102 during the operation of power distribution circuit 100, which will be discussed in further detail below.

It should be noted that while the embodiment of power distribution circuit 100 shown in FIG. 2 includes positive voltage sources and n-channel FETs, other embodiments utilizing p-channel FETs are possible and contemplated. Embodiments utilizing negative voltage sources and/or bi-polar transistors are also possible and contemplated. It should further be noted that in embodiments utilizing p-channel FETs the polarity of the source and drain terminals may be reversed. However, the polarity of the body diode may remain the same as shown in FIG. 2 regardless of whether p-channel or n-channel FETs are used.

Each of transistors 102 may be coupled to a control unit IC 105. In the embodiment shown, the source terminal of each transistor 102 is coupled to a source voltage input, V_{S}. A single drain voltage input, V_{D}, may be coupled to power node 103, which in turn may be coupled to each of the drain terminals of transistors 102. A gate terminal of each of transistors 102 may be coupled to a bias voltage output, V_{G}. Control unit IC 105 may be configured to monitor the voltage difference between the drain and source terminals of each of transistors 102. The bias voltage outputs may be controlled based on the voltage difference between the drain and source nodes. Thus, each of transistors 102 may be turned on or off based on the voltage difference detected between its drain and source terminals.

Power distribution circuit 100 may have multiple modes of operation. A first mode of operation may occur during an initial power-up phase. The initial power-up phase may begin when one or more of power sources V_{A}, V_{B}, and V_{C} is energized. For sake of simplicity, the discussion here will assume that each of the power sources is energized simultaneously, although it may be possible to energize each of the power sources independently and at different times. When power sources V_{A}, V_{B}, and V_{C} are initially energized, each of transistors 102 may be in a deactivated (off) state. When transistors 102 are in an off state, they may behave as a diode. In this state, the voltages of the power sources may be transferred across the body diode of transistors 102. The voltage on power node 103 may rise to a voltage near the voltage of the power sources. Control unit IC 105 may receive power through its power input (labeled here as ‘Pwr’). Thus, control unit IC may then begin charging internal circuitry (as will be discussed further below) in order to generate bias voltages on each of the outputs V_{B} in order to activate transistors 102. The bias voltage from the outputs V_{G} may be conveyed to the gate terminal of each of transistors 102. After reaching a sufficient bias voltage on each of the gate terminals, transistors 102 may be activated, and power distribution circuit 100 may enter a second mode of operation.

A second mode of operation may be referred to as the normal mode. In the normal mode of operation, each of transistors 102 may be activated. When transistors 102 are activated, current may be allowed to flow between the source and the drain of each of transistors 102. The voltage drop encountered by the current flowing between the source and the drain of each transistors 102 may be governed by the drain-source resistance, R_{DS}. A typical drain-source resistance may be on the order of approximately 10 milliohms. Thus, using a current of 10 amperes as an example, a power loss of 1 watt may result. This may be significantly less than the power loss of a power distribution circuit utilizing diodes instead of field effect transistors such as transistors 102. The reduced power loss may lead to less thermal dissipation occurring in power distribution circuit 100.

During the second mode of operation, each of transistors 102 ray provide a diode function in accordance with body diodes 110. The diode function of transistors 102 may be activated when the voltage difference between one or more of power sources V_{A}, V_{B}, and V_{C} and power node 103 is sufficient to forward bias a corresponding body diode 110.

When a body diode 110 is forward biased, current may flow from the anode to the cathode of the body diode. In the embodiment shown, current flow in this direction may be equivalent to current flowing from one of power sources V_{A}, V_{B}, and V_{C} to power node 103. When the voltage difference between a power source and power node 103 is insufficient to cause a respective body diode 110 to be reverse biased, a small amount of leakage current may flow in the reverse direction through the corresponding transistor 102. In either case, the power losses may be minimal, as power losses in this case may be governed by drain-source resistance R_{DS}.

During the operation of electronic system 20, electrical transients may be encountered due to various reasons. For example, sudden changes in current demand may be caused by the simultaneous switching of a large number of devices. This may in turn lead to voltage fluctuations on the power planes of electronic system 20. These voltage fluctuations may be transferred onto power node 103. If such a voltage fluctuation is encountered on power node 103, it may cause power distribution circuit 100 to enter a third mode of operation, known as a reverse bias mode. Control unit IC 105 may monitor the voltage difference between the drain and source terminals of each of transistors 102. In the embodiment shown, if the voltage on the source terminal becomes less than the voltage on the drain terminal for one of transistors 102, control unit IC 105 may deactivate that transistor by removing the required bias voltage from its gate terminal. In this third mode of operation, a transistor 102 that is deactivated may behave as a diode that is reverse biased. Due to the tolerances of power sources V_{A}, V_{B}, and V_{C}, the voltages present on the source terminals of transistors 102 may vary slightly from one to the other. Thus, it may be possible in some embodiments for one transistor to be operating in the third mode while another transistor to be operating in the second mode. However, it is also possible that each of transistors 102 to be operating in the same mode at a given moment.

A fourth mode of operation may be referred to as a null state. In the null state, there may be no detectable voltage difference between the drain terminal and the source terminal of a given transistor 102. In the null state, control unit IC 105 may maintain the current state of a transistor 102. If a given transistor 102 is activated when the null state is entered, it may remain activated. Similarly, if a given transistor 102 is inactive when the null state is entered, it may remain inactive. The null state may be maintained until a voltage difference is detected by control unit IC 105. Once a voltage difference is detected, either the normal mode or the reverse bias mode may be entered depending on the relative voltages present on the drain and source terminals.

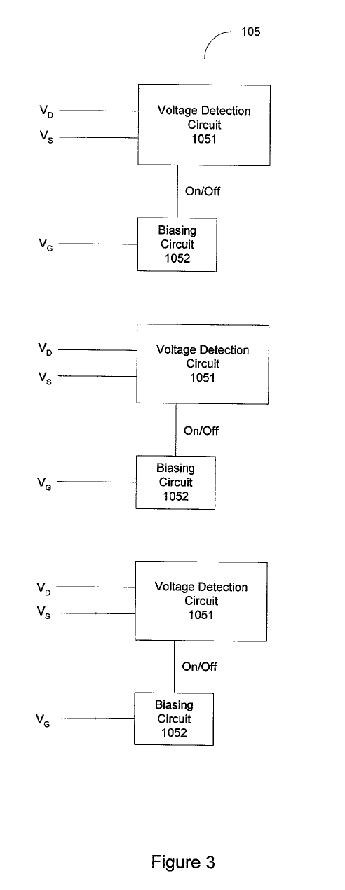

Moving now to FIG. 3, a block diagram of one embodiment of control unit IC 105 is shown. Control unit IC 105 may be similar to the control unit IC shown in FIG. 2. In the embodiment shown, control unit IC 105 includes a plurality of voltage detection circuits 1051 and a plurality of biasing circuits 1052. Voltage detection circuits 1051 may include a pair of inputs, V_{D} and V_{S}. Inputs V_{D} and V_{S} may be electrically coupled to drain and source terminals of a transistor 102, respectively. Voltage detection circuits 1051 may be configured to detect the difference between the drain and source voltages of an associated transistor 102. An on/off output may be toggled based on the detected voltage difference between the terminals. In one embodiment, the on/off output may be placed in the on state if the voltage magnitude on the drain terminal is less than the voltage magnitude on the source terminal. Alternatively, if the voltage magnitude of the source terminal is less than the voltage magnitude of the drain terminal, the on/off output may be placed in the off state.

The on/off output from one of voltage detection circuits 1051 may be received as an input by an associated biasing circuit 1052. If the on/off output from a voltage detection circuit 1051 is in the on state, the associated biasing circuit 1052 may generate a sufficient bias voltage on its output V_{G} to activate an associated transistor 102. Conversely, if the on/off output from a voltage detection circuit 1051 is in the off state, the associated biasing circuit 1052 may reduce the voltage present on the V_{G} output to a level below the voltage required for activating an associated transistor 102. Thus, the associated transistor 102 may be placed in an inactive state when the on/off output from a voltage detection circuit 1051 is placed in the off state.

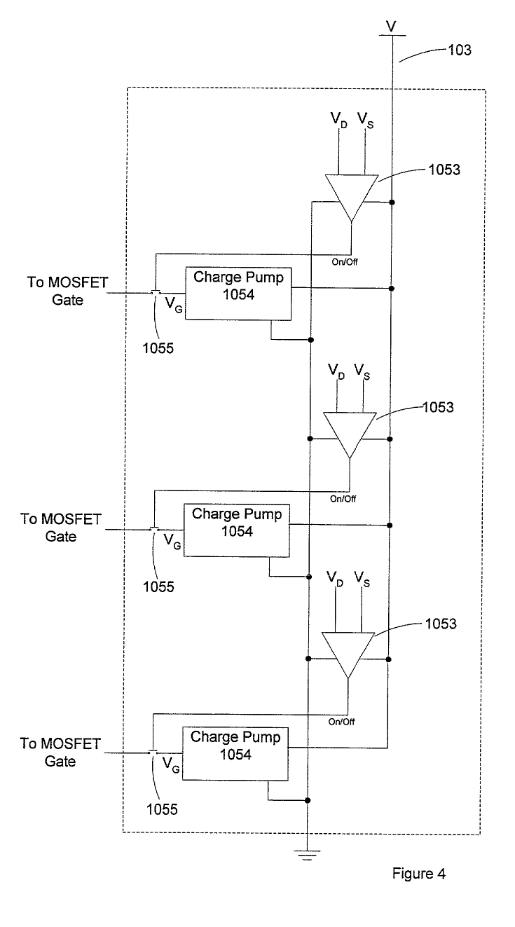

Turning now to FIG. 4, a schematic diagram of one embodiment of a control unit IC is shown. Control unit IC 105 may include a plurality of comparators 1053 and a plurality of charge pumps 1054. Comparators 1053 may provide the function of voltage detection circuits 1051 shown in FIG. 3. Similarly, the function of biasing circuits 1052 of FIG. 3 may be provided by charge pumps 1054. In the embodiment shown, comparators 1053 may be analog comparators. Alternate embodiments including analog-to-digital converters and digital comparators are possible and contemplated. Each of comparators 1053 may be electrically coupled to a drain terminal and a source terminal of a transistor 102. In this particular embodiment, the output of a given comparator 1053 may be placed in the on state if the voltage present on input V_{D} is lower in magnitude than the voltage present on input V_{S}. If the on/off output is in the on state, it may close a switch 1055. When a switch 1055 is closed, a bias voltage sufficient for activating a transistor 102 may be conveyed from an associated charge pump 1054. On the other hand, if the voltage magnitude present on input V_{D} of a comparator 1053 is greater than the voltage magnitude present on the V_{S} input, the on/off output may be placed in an off state. In the off state, the associated switch 1055 may be open. When a switch 1055 is open, it may prevent a sufficient bias voltage from being conveyed to an associated transistor 102 by a charge pump 1054.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A power distribution circuit comprising:
a control unit IC (integrated circuit); and
a plurality of transistors, wherein each of the plurality of transistors includes a first terminal, a second terminal, and a control terminal, wherein the control terminal of each of the plurality of transistors is coupled to the control unit IC, wherein the first terminal of each of the plurality of transistors is coupled to a power source, and wherein the second terminal of each of the plurality of transistors is coupled to a power node for supplying power to an electronic system;
wherein the control unit IC is configured to activate at least one of the plurality of transistors by driving a bias voltage onto the control terminal of the at least one transistor, and wherein the control unit IC is configured to monitor a voltage difference between the first terminal and the second terminal.

2. The power distribution circuit as recited in claim 1, wherein the control unit IC is mounted in a surface mount package.

3. The power distribution circuit as recited in claim 1, wherein the first terminal and the second terminal of each of the plurality of transistors is coupled to the control unit IC.

4. The power distribution circuit as recited in claim 3, wherein the control unit IC includes a voltage detection circuit, and wherein the voltage difference between the first terminal and the second terminal of each of the plurality of transistors is monitored by the voltage detection circuit.

5. The power distribution circuit as recited in claim 4, wherein the control unit IC is configured to de-activate the one of the plurality of transistors responsive to the voltage detection circuit detecting that the voltage magnitude on the first terminal is less than the voltage on the second terminal.

6. The power distribution circuit as recited in claim 3, wherein the voltage detection circuit is a comparator.

7. The power distribution circuit as recited in claim 6, wherein the comparator is an analog comparator.

8. The power distribution circuit as recited in claim 1, wherein the control unit IC includes a biasing circuit, and wherein the biasing circuit is configured to apply a bias voltage to the control terminal of each of the plurality of transistors.

9. The power distribution circuit as recited in claim 8, wherein the biasing circuit is a charge pump.

10. The power distribution circuit as recited in claim 1, wherein each of the plurality of transistors is a field effect transistor (FET), wherein the first terminal of each transistor is a source terminal, the second terminal of each transistor is a drain terminal, and the control terminal of each transistor is a gate terminal.

11. A method for distributing power to an electronic circuit, the method comprising:
providing a plurality of power sources;
providing a control unit IC (integrated circuit); and
providing a plurality of transistors, wherein each of the transistors includes a first terminal, a second terminal, and a control terminal, wherein the first terminal of each of the plurality of transistors is coupled to one of the plurality of power sources, wherein the second terminal of each of the plurality of transistors is coupled to a power node of an electronic circuit, and wherein the control terminal of each of the plurality of transistors is coupled to the control unit IC, wherein the control unit IC is configured to activate one of the plurality of transistors by driving a bias voltage onto the control terminal of the one of the plurality of transistors, and wherein the control unit IC is configured to monitor a voltage difference between the first terminal and the second terminal of the one of the plurality of transistors.

12. The method as recited in claim 11, wherein the control unit IC is mounted in a surface mount package.

13. The method as recited in claim 11 further comprising the control unit IC de-activating the one of the plurality of transistors responsive to detecting that the voltage magnitude on the first terminal of the one of the plurality of transistors is less than the voltage on the second terminal of the one of the plurality of transistors.

14. The method as recited in claim 13, wherein the voltage difference between the first terminal and the second terminal is monitored by a voltage detection circuit.

15. The method as recited in claim 14, wherein the voltage detection circuit is a comparator.

16. The method as recited in claim 15, wherein the comparator is an analog comparator.

17. The method as recited in claim 11, wherein the control unit IC includes a biasing circuit, and wherein the biasing circuit is configured to apply a bias voltage to the control terminal of each of the plurality of transistors.

18. The method as recited in claim 17, wherein the biasing circuit is a charge pump.

19. The method as recited in claim 11, wherein each of the plurality of transistors is a field effect transistor (FET), and wherein the first terminal of each of the plurality of transistors is a source terminal, the second terminal of each of the plurality of transistors is a drain terminal, and the control terminal of each of the plurality of transistors is a gate terminal.

20. A power control unit IC (integrated circuit) comprising:
a plurality of voltage detection circuits, wherein each of the voltage detection circuits is configured to detect a voltage difference between a first transistor terminal and a second transistor terminal;
a plurality of biasing circuits, wherein each of the plurality of biasing circuits is coupled to one of the plurality of voltage detection circuits; and
a plurality of switches, wherein each of the plurality of switches, when closed, is configured to allow a bias voltage from one of the plurality of biasing circuits to be driven onto a transistor control terminal, and wherein each of the plurality of voltage detection circuits is configured to cause an associated one of the plurality of switches to open responsive to detecting that the voltage magnitude on an associated first transistor terminal is less than the voltage magnitude on an associated second transistor terminal.

21. The power control unit IC as recited in claim 20, wherein the power control unit IC is mounted in a surface mount package.

22. The power control unit IC as recited in claim 20, wherein each of the plurality of voltage detection circuits is a comparator.

23. The power control unit IC as recited in claim 22, wherein the comparator is an analog comparator.

24. The power control unit IC as recited in claim 20, wherein the biasing circuit is a charge pump.

25. The power control unit IC as recited in claim 20, wherein the first transistor terminal is a source terminal, the second transistor terminal is a drain terminal, and the control terminal is a gate terminal.
